(19) United States
(12) Patent Application Publication
(10) Pub. No.: US 2005/0079475 A1
(43) Pub. Date: Apr. 14, 2005

(54) Breast cancer detection

(76) Inventor: Paulin Haque, Bury St Edmunds (GB)

Correspondence Address: BOURQUE & ASSOCIATES, P.A., 835 HANOVER STREET, SUITE 303, MANCHESTER, NH, 03104, US

(21) Appl. No.: 10/476,433

(22) PCT Filed: May 1, 2002
(86) PCT No.: PCT/GB02/01987

(30) Foreign Application Priority Data
May 3, 2001 (GB) 0110847.1

(51) Int. Cl. G09B 23/28

(52) U.S. Cl. 434/267; 434/273

(57) ABSTRACT

A training aid to be used in training women or men to carry out examination of their breasts to give early warning of the development of possibly cancerous lumps. The aid is in the form of a life-size replica torso (10), with two breasts made so that they are as alike as possible in size, texture and position to human breasts. One breast (20) is formed with a texture and/or implants representative of diseases where the symptoms are detectable by touch, while the other breast (22) is made to resemble a healthy, undiseased breast.

This invention relates to a training aid to assist in training men or women how to conduct a breast examination for the presence of breast lumps.

Breast cancer is commonly characterised by lumps in the breast tissue, although other symptoms are nipple discharge, breast pain, skin changes and nipple inversion.

Breast cancer is a form of cancer which is quite widespread but which can be detected in its early, and treatable, stages by regular self-examination of the breasts. Training aids are known, for example as shown in U.S. Pat. No. 4,001,951, which provide a simulated breast implanted with lumps, so that a woman can herself palpate the simulated breast and become aware of what cancerous lumps feel like.

According to the invention, there is provided a training aid comprising a model of part of a torso, the model having a front face provided with an artificial skin and two breasts, the texture and feel of which resemble human skin and breasts, one of the breasts being formed with a texture and/or implants representative of diseases where the symptoms are detectable by touch, while the other breast is made to resemble a healthy, undiseased breast.

In a preferred form, the diseased breast will be implanted with lumps resembling cancerous lumps. However the diseased breast may alternatively be made to represent other diseases which are detectable by touch, eg inverted nipple and/or puckering of the skin. The healthy breast may be implanted with simulated benign lumps which are often present in healthy breasts.

The aid is to be used by a woman standing behind the aid who can then hold and feel the breasts, which are then in substantially the same position relative to her body as her own breasts, and can feel the difference between a healthy breast and a diseased breast with a direct, side-by-side comparison. The woman being taught can be shown exactly what procedure to use to examine her own breasts, because her hands and arms will move relative to the model in very much the same movements as they would when she examines her own breasts.

The back of the aid can be hollowed out, so that the woman being trained can position the aid close to the front of her own body.

The aid can also have upper arms, connected to the rest of the aid through pivoted shoulder joints, with the artificial skin covering the joints.

A recognised part of breast cancer examination calls for the subject to lift her arms so as to stretch the skin between the breasts and the shoulders. This area must then be checked for possible cancerous lumps. The use of pivoting arms on the aid allows this part of self-examination also to be demonstrated on a model.

The aid can be mounted on a stand, and the height of the model can be adjusted. The stand can be hinged, so that the aid can be swung forwards or backwards between vertical and horizontal positions, and can be locked at any intermediate position.

The aid can have means for warming the breasts, so that they are at normal body temperature when the training is being conducted. The aid can also have simulated ribs behind the breasts and/or a simulated muscle layer underlying the breasts from the underarm region across the ribcage, to add to the resemblance of the aid to the human form.

To add to the similarity between the model and human breasts, the aid can have means to vary the size and firmness of the breasts. For example, there may be a pump for pumping additional material into the aid, from behind the positions of the breasts, to increase their size and or firmness. The additional material could be air or a fluid of similar density to the material forming the breasts themselves. It would also be possible to use a material for the breasts which can change texture or expand or experience other property changes on application of an electrical current, and an electrical circuit can be arranged to apply appropriate current.

The invention will now be further described, by way of example, with reference to the accompanying drawings, in which:

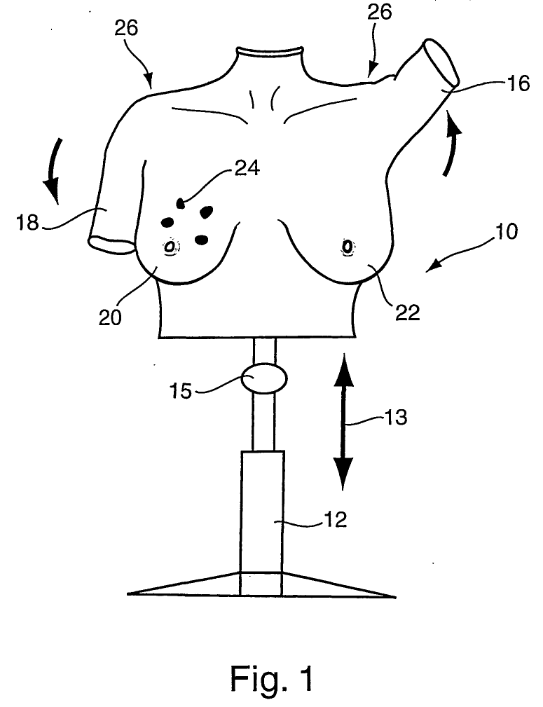

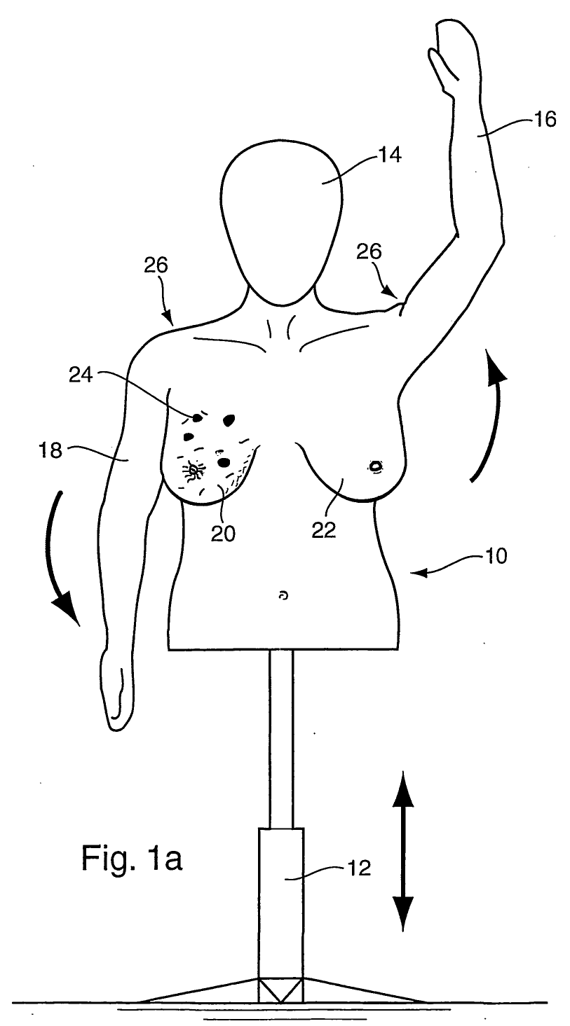

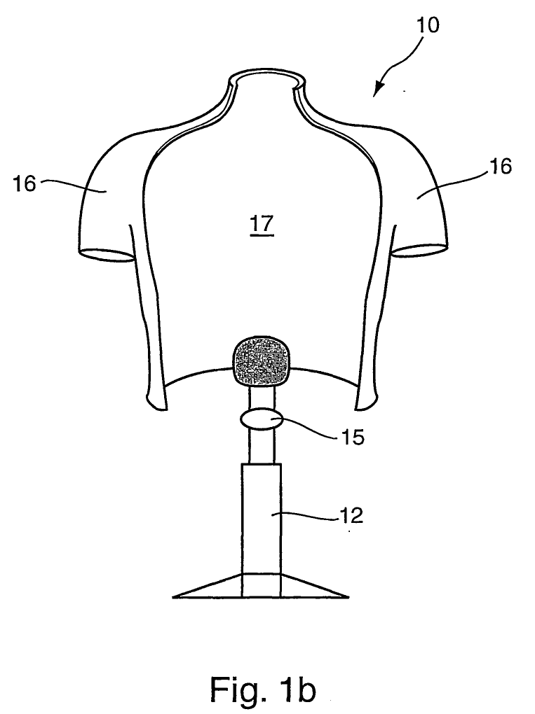

FIG. 1 is a front view of a training aid in accordance with the invention;

FIG. 1a is a view similar to FIG. 1, of an alternative embodiment;

FIG. 1b shows a back view of the aid of FIG. 1a or FIG. 1b.

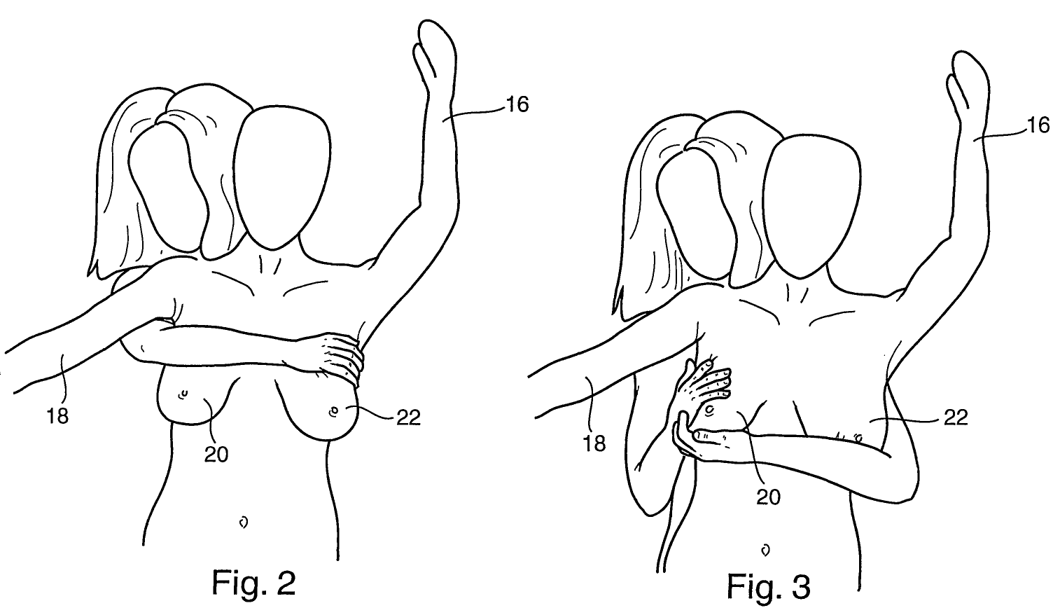

FIGS. 2 and 3 show two different training techniques being carried out using the aid of FIG. 1;

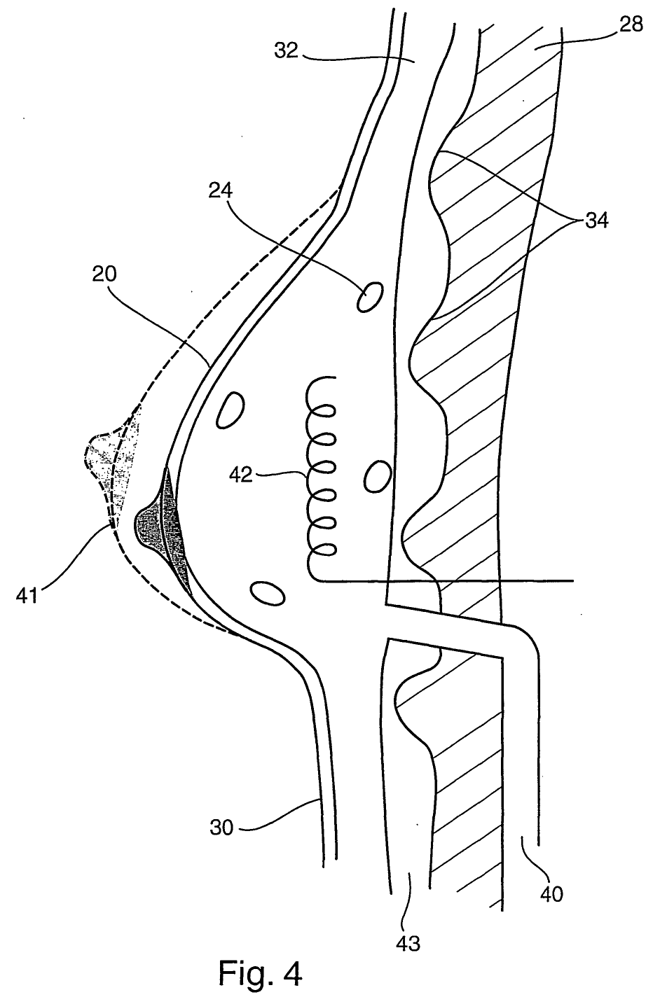

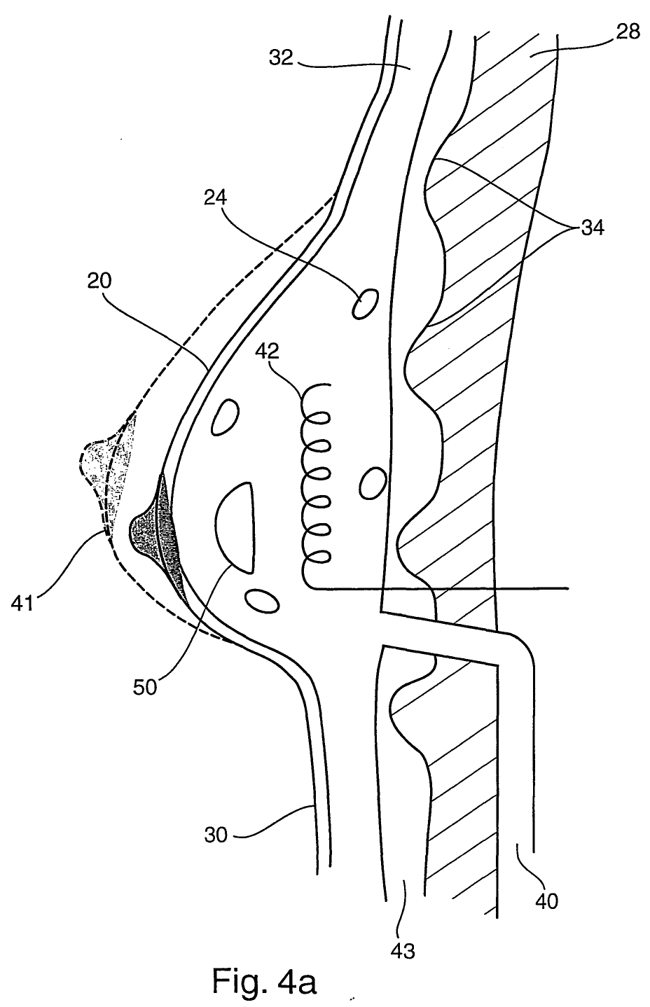

FIG. 4 is a vertical section through the aid, on a line passing through one of the breasts;

FIG. 4a is a vertical section through a second embodiment of the aid on a line passing through one of the breasts;

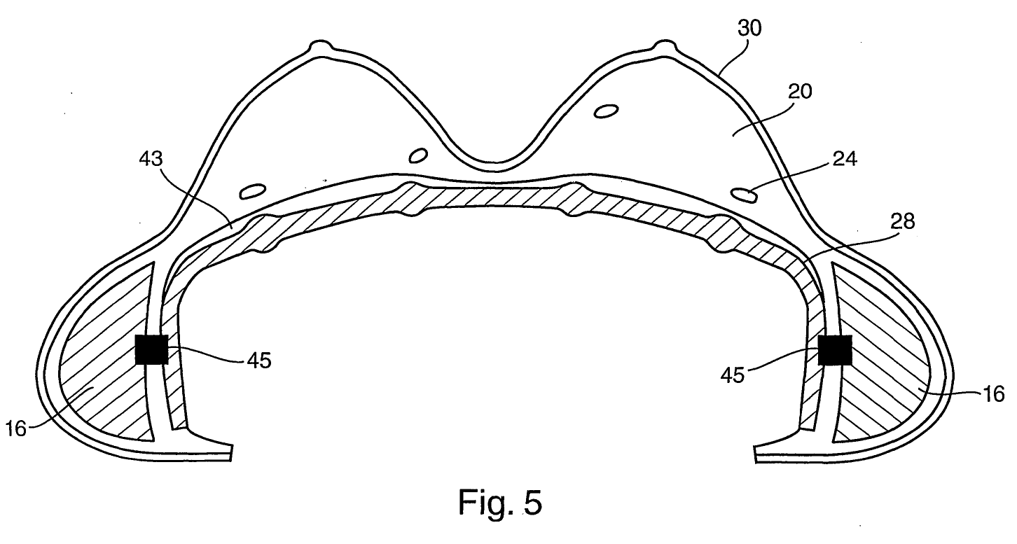

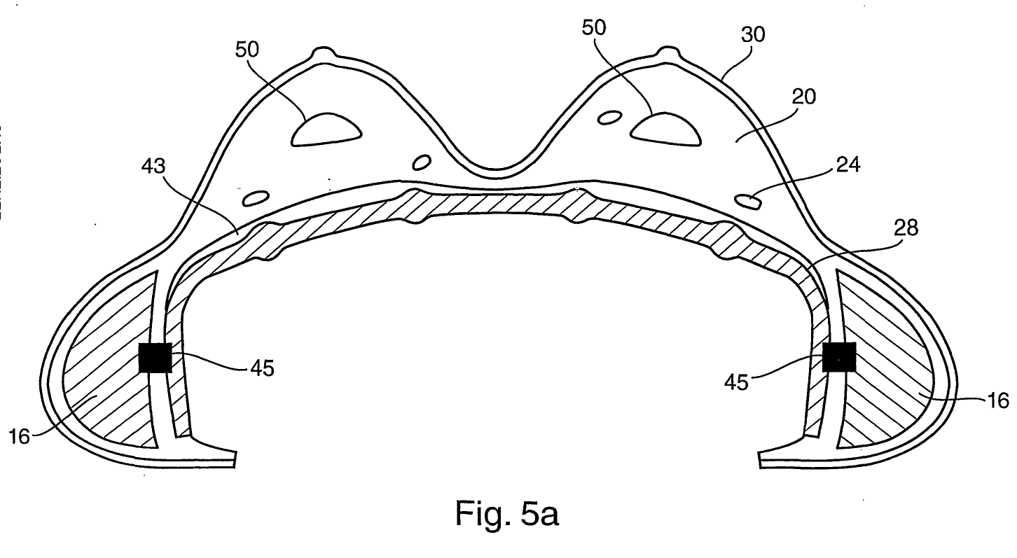

FIG. 5 is a horizontal section through the torso of FIG. 4;

FIG. 5a is a horizontal section through the torso of FIG. 4a; and

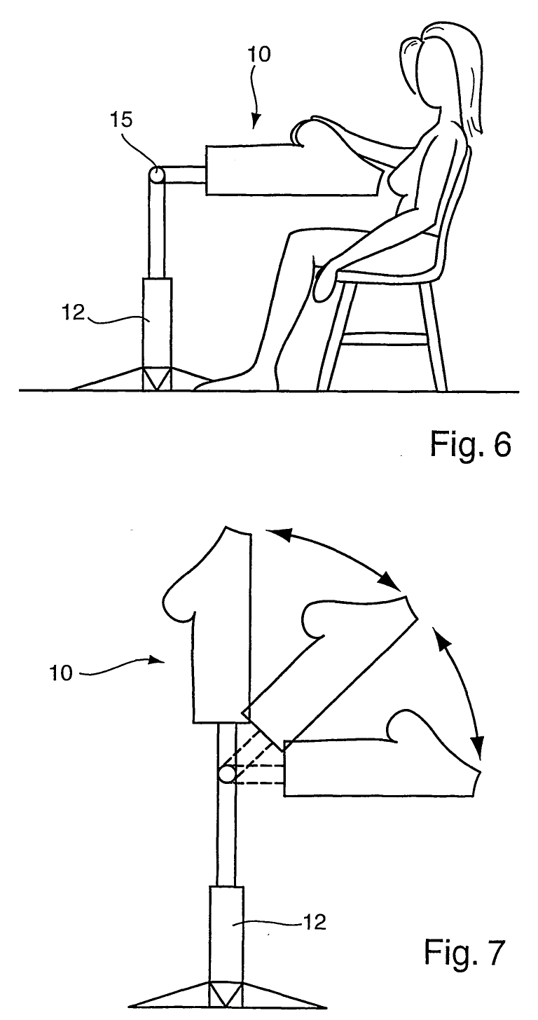

FIGS. 6 and 7 illustrate an aid mounted on a stand which is hinged, and may be swung forwards and backwards between horizontal and vertical positions and locked in any intermediate position.

FIG. 1 shows a model 10 of a female torso mounted on a stand 12. The model can be moved up and down (see arrow 13) by adjusting the stand, and many different ways in which stand height can be altered are well known. The stand may also have a joint 15 through which the torso can be angled relative to the ground.

Whilst the description and accompanying drawings show a female torso, and refer to female breast self examination, breast cancer does occur in men, and the invention is equally applicable to a training aid comprising a male torso.

The model has two upper arms 16 and 18 and two breasts 20 and 22. The model can however be made with a head 14, with full length arms and with a longer body (see FIG. 1a).

FIG. 1b shows a back view of the model. In this figure it can be seen that the back of the model is hollow, at 17, to allow a user to stand close up behind the model.

One breast 20 has lumps 24 implanted into it, in positions where cancerous lumps are likely to occur. The other breast 22 may have normally occurring benign lumps implanted in it.

The arms 16 and 18 are jointed to the body so that they can move about shoulder joints (indicated generally at 26).

An example of the manner in which the model can be constructed will be described with reference to FIGS. 4, 4a, 5 and 5a.

The model has a rigid backing plate 28, which may for example be moulded from glass fibre reinforced plastics, and a flexible skin 30. Between the skin and the backing plate is an intermediate layer 32 of yieldable material (for example a silicon gel). The design intent is that materials should be chosen for the skin and the intermediate layer to resemble as closely as possible the feel of a human body. The material of the intermediate layer may be self-skinning, in which case a separate skin layer would be unnecessary. The intermediate material in the area of the breasts may be the same as or different from the material in the rest of the space between the skin 30 and the backing plate 28.

FIGS. 4a, and 5a illustrate an embodiment of the invention in which a vesicle 50 comprising a gel filled bladder, which aids the natural feel of the breasts, forms the intermediate material in the area of the breasts. The gel in this example is of lower viscosity than the intermediate material in the rest of the space between the skin 30 and the backing plate 28.

One difference between malignant lumps and benign lumps is that benign lumps tend to move more readily than malignant lumps. Malignant lumps may attach themselves to surrounding cells thus restricting their movement. Where a vesicle 50 containing a material of a lower viscosity than the material of the surrounding area is used then either breast 20, 22 may have benign lumps implanted into the gel filled vesicle. The simulated diseased breast 20 has malignant lumps implanted into the surrounding area within the less viscous intermediate material.

The backing plate 28 is shown formed with ribs 34, the presence of which will be apparent when feeling the outer surface of the model, in the same way in which human ribs can be felt through the skin. In the region of the breast 20, the form of the breast is created by the material of the intermediate layer 32, and it is in this intermediate layer that the lumps 24 are embedded.

FIG. 5 shows how the back of the model can be formed with a hollow 17, so that a woman being trained can position herself closely behind the model so that the arms and body of the model are in a position close to those of the woman's own arms and body.

FIG. 4 also shows a tube 40 through which fluid or air can be injected into the breast chambers in the model, to increase the size and/or firmness of the breasts so that they more closely resemble the breast size/firmness of the woman being trained. Phantom lines at 41 indicate this enlargement of one breast after injection of fluid through the tube 40.

A simulated muscle layer 43 can be included in the model.

FIG. 5 also shows shoulder joints at 45.

Heating elements 42 can also be included in the breasts 20, 22 so that the breasts can be warmed to body temperature before the aid is used.

It is also possible to include a circuit connected to a light source embedded in simulated malignant lumps in order to aid location of such lumps in the first instance.

In use, a trained professional (TP) will first demonstrate to the patient how to use the aid. The torso will be adjusted for height so that the shoulders of the torso are in line with the shoulders of the TP. The TP will stand behind the torso (see FIGS. 2 and 3) and then give a full demonstration of breast self-examination. This will include raising each arm in turn (FIG. 2) to check for lumps above the breasts and under the armpit, and lifting and feeling each breast in turn (FIG. 3). When feeling for lumps in the breasts themselves, the healthy breast will be used for comparison of feel.

The TP will then sit behind the training aid and angle the aid (see FIGS. 6 and 7) to approximately 30 degrees to the horizontal and then repeat a demonstration of breast self examination, this time simulating the patient lying down on their back. When the aid is in the position shown in FIG. 6, the breast will take up the same position as they would on the patient herself, when she is lying down.

The patient will take her turn to carry out the instructions of the TP.

One important aspect of breast examination is the sequence in which parts of the breasts and surrounding areas are examined. A possible enhancement to the training aid is the addition of surface markings to the torso, to indicate such a preferred sequence. Such markings, which could be in the form of arrows, for example, will aid the patient in visualising and remembering the order in which the examination should be carried out.

This training aid will enable all females from adolescent age onwards to be properly shown how to carry out breast self-examination. With proper training this will encourage women to adopt regular monthly checking for early signs of breast tumours/lumps because they will have been shown how to do it physically and they will have gained the knowledge of what to look and feel for.

Research has shown that the effectiveness of breast self-examination relies on the effectiveness of the physical palpation process itself. Over 90% of breast cancers can be felt and are able to be detected early. It is estimated that the expected death rate due to breast cancers could be halved if the size of undetected tumours could be reduced to less than about 2 cm.

The objective of this training aid is to overcome the embarrassment, taboo, it will never happen to me attitude, of women on this very serious disease. A common excuse is “I don't examine my breasts regularly because I don't really know what I'm supposed to be feeling for!” Mortality from breast cancer depends on when the disease is first diagnosed. Early detection will dramatically reduce the number of fatalities. It will educate and give confidence to all females on breast self-examination and abnormality detection. The aim of this training aid is to educate women so that they will adopt this method as part of their lifestyle, like brushing their teeth twice a day.

1. A training aid comprising a model of part of a torso, the model having a front face provided with an artificial skin and two breasts, the texture and feel of which resemble human skin and breasts, one of the breasts being formed with a texture and/or implants representative of diseases where the symptoms are detectable by touch, while the other breast is made to resemble a healthy, undiseased breast.

2. A training aid according to claim 1, in which the diseased breast is implanted with simulated malignant lumps resembling cancerous lumps.

3. A training aid according to claim 1 or claim 2, in which the healthy breast is implanted with simulated benign lumps.

4. A training aid according to any one of the preceding claims, in which each breast includes a vesicle containing a material of lower viscosity than surrounding material.

5. A training aid according to claim 4, in which either breast has simulated benign lumps implanted in the vesicle.

6. A training aid according to claim 4 or claim 5, in which the diseased breast has simulated malignant lumps implanted in the surrounding material.

7. A training aid according to any one of the preceding claims, wherein the back of the aid is hollowed out, so that the woman being trained can position the aid close to the front of her own body.

8. A training aid according to any one of the preceding claims, which also has upper arms, connected to the rest of the aid through pivoted shoulder joints, with the artificial skin covering the joints.

9. A training aid according to any one of the preceding claims, wherein means are provided for warming the breasts, so that they are at normal body temperature when the training is being conducted.

10. A training aid according to any one of the preceding claims, wherein means are provided for illuminating malignant lumps.

11. A training aid according to any one of the preceding claims, wherein the aid includes simulated ribs behind the breasts to add to the resemblance of the aid to the human form.

12. A training aid according to any one of the preceding claims, wherein the aid is mounted on a stand.

13. A training aid as claimed in claim 12, wherein the height of the model on the stand can be adjusted.

14. A training aid as claimed in claim 12 or claim 13, wherein the stand is hinged, so that the aid can be swung forwards or backwards between vertical and horizontal positions, and can be locked at any intermediate position.

15. A training aid as claimed in any preceding claim, wherein means are provided to vary the size of the breasts.

16. A training aid as claimed in claim 15, wherein the means for varying the size of the breasts comprises a pump for pumping additional material into the aid, from behind the positions of the breasts, to increase their size.

17. A training aid as claimed in claim 16, wherein the additional material is a fluid of similar density to the material forming the breasts themselves.

18. A training aid according to any one of the preceding claims, in which the diseased breast is made to represent other diseases which are detectable by touch.

19. A training aid substantially as herein described with reference to the accompanying drawings.
